(19) United States
(12) Patent Application Publication
(10) Pub. No.: US 2005/0254930 A1
(43) Pub. Date: Nov. 17, 2005

(54) Load pusher

(76) Inventors: Russell Weinstein, Sherman Oaks, CA (US); Denny Eichenbaum, San Rafael, CA (US); Matthew Snyder, Sherman Oaks, CA (US)

Correspondence Address: SoCAL IP LAW GROUP LLP, 310 N. WESTLAKE BLVD. STE 120, WESTLAKE VILLAGE, CA, 91362, US

(21) Appl. No.: 10/845,861

(22) Filed: May 14, 2004

(51) Int. Cl. B65G 1/00

(52) U.S. Cl. 414/659

(57) ABSTRACT

There is disclosed a pusher apparatus for pushing cargo, containers, boxes or goods. The pusher apparatus may comprise a first section. The first section may comprise a fork sleeve. The pusher apparatus may comprise a second section for pushing a load. The second section may be pivotally joined to the first section. The second section may be disjoinable from the first section. The pusher apparatus may comprise a detachable member for supporting the second section. The detachable member may be affixed to the second section apart from an axis where the second section is pivotally joined to the first section. The detachable member may be affixed to the first section apart from the axis.

### BACKGROUND OF THE INVENTION

1. Field of the Invention

The present invention relates to cargo loading,

2. Description of the Related Art

Global trade has been conducted for thousands of years. Every day vast quantities of goods are shipped around the world via aircraft, boat, train, truck, and automobile. Modern cargo aircraft and vessels ship containers to and from ports all over the world. Market demands require that participants in the shipping industry operate in both a time and cost competitive fashion. In turn, logistics operators strive to optimize the amount of goods that are packaged within a standard shipping container.

The shipping industry has developed and utilized a variety of machines and mechanisms for transporting goods to and from a container, and containers to and from a transport vehicle. Such machines and mechanisms include cranes, fork lifts, flat bed trucks, elevator ramps, palettes, buckets, and slip sheets.

As cost to transport goods is, at least in part, based on mass or weight, manufacturers of containers and other shipping materials have more frequently utilized light weight materials such as aluminum and composites rather than traditional steel and wood. Additionally, modern transport vehicles run on alternative lower cost and lower emission fuels such as liquid natural gas (LNG) and electric fuel cells.

The transportation of goods or merchandise frequently entails loading and unloading boxes, crates, or containers to and from an airplane, ship, or vehicle. Common cargo containers may be as large as forty feet in length and may carry over sixty thousand pounds of weight. Smaller cargo containers may be eight feet in length and may carry nine thousand pounds of weight. However, not all goods are shipped in cargo containers or boxes. Some goods are shipped solely in bubble wrap or covered in plastic due to their geometry and mass. Because of the bulk and weight of many boxes, containers, and goods, loading and unloading processes require machinery such as cranes, elevators, trucks, forklifts, and container/pallet loaders.

### DESCRIPTION OF THE DRAWINGS

FIG. 1 is a perspective view of a pusher accessory displacing cargo.

FIG. 1A is a perspective view of a forklift truck.

FIG. 1B is a plan view of a fork.

FIG. 2 is a plan view of a pusher accessory.

FIG. 3 is a partial perspective view of a pusher accessory.

FIG. 5 is a plan view of a pusher accessory.

FIG. 6 is a plan view of a pusher accessory.

FIG. 7 is a perspective view of a detachable member.

FIG. 8 is a partial plan view of a pusher accessory.

FIG. 9 is a partial perspective view of a first section.

FIG. 10 is a perspective view of a pusher accessory.

FIG. 11 is a partial perspective view of a pusher accessory.

FIG. 12 is a perspective view of a detachable member.

FIG. 13 is a partial perspective view of a first section.

FIG. 14 is a partial plan view of a first section.

FIG. 15 is a partial perspective view of a pusher accessory.

### DETAILED DESCRIPTION OF THE INVENTION

Throughout this description, the embodiments and examples shown should be considered as exemplars, rather than limitations on the apparatus and methods of the present invention.

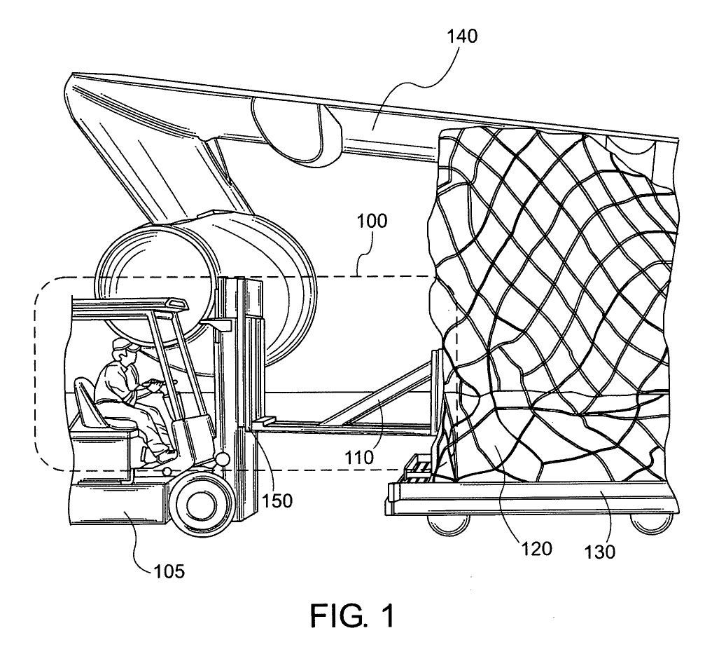

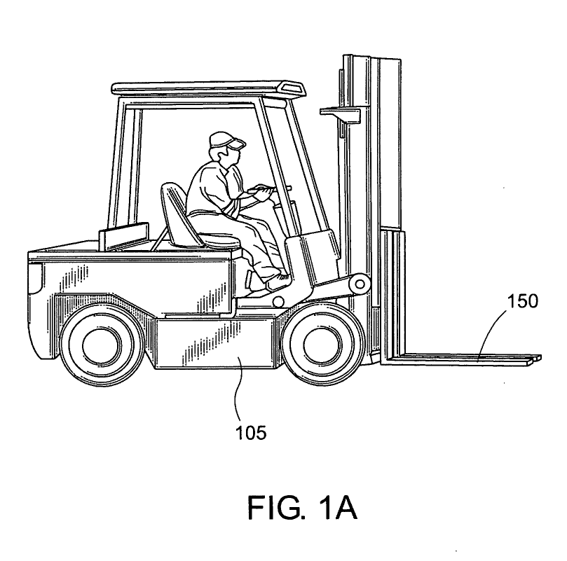

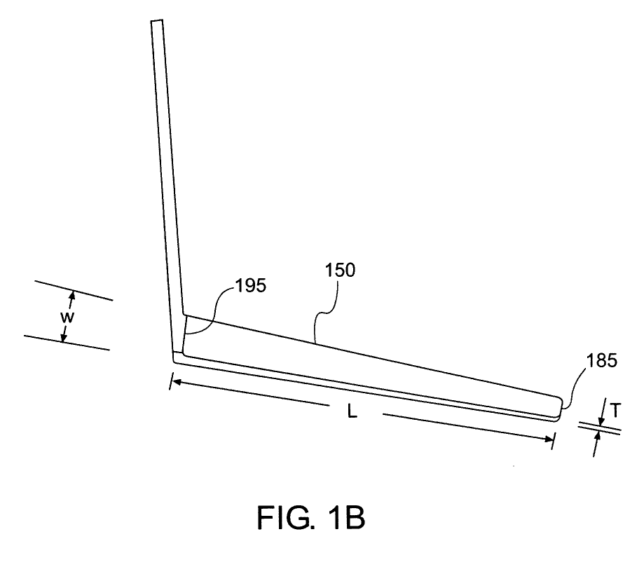

Referring now to FIG. 1, there is shown a pusher apparatus 100. The pusher apparatus 100 may include a forklift truck 105 and a pusher accessory 110. The forklift truck 105 may include a fork 150, as shown in FIG. 1A. The pusher accessory 110 may be coupled to the fork 150. The pusher apparatus 100 may horizontally displace a cargo 120 along a conveyor 130 into a cargo aircraft 140.

The forklift truck 105 is an example of a machine used for cargo logistics or material handling. The pusher apparatus 100 may displace the cargo 120 with a machine, for example, a baggage tractor, a tri-wheel multi-tire lift truck, a low lift pallet truck, a walkie straddle, a walkie reach, a tractor, a crane, a pick up truck, a bull-dozer, a stationary robotic displacement machine, or a conveyor accessory. The machine may be electric, gasoline, diesel, LPG, pneumatic, hydrogen powered, or powered by another fuel.

The forklift truck 105 may include one fork 150, two forks 150, or some other number and arrangement of forks 150. The fork 150 may be attached to the forklift truck 105 at the front, back, or side of the forklift truck 105. The fork 150 may be attached to the forklift truck 105 via a pin and clip kit, a quick coupler, bolts, welding, steel position locking latches, or other fastener.

Referring now to FIG. 1B, there is shown a plan view of the fork 150. The fork 150 may be a standard Industrial Truck Association (ITA) fork. The fork 150 may have a standard taper or a full taper. Standard tapers are commonly used in picking up skids or pallets. Typically, standard tapers begin 16 inches to 24 inches from the tip 185 and end with a ⅜″ wide tip 185. Full tapers are typically used for positioning the forks 150 under plywood or cardboard boxes. Typically, full tapers begin at the heel 195 of the fork and extend to the tip 185. Standard ITA forks may be manufactured from 1″ to 3″ in thickness T, from 1.5″ to 8″ in width W, and from 36″ to 96″ in length L.

The fork 150 is typically selected based on the size and mass of the load that the fork 150 may be required to lift and move. Additional types of forks include, for example, a block fork, a brick fork, a tire fork, a chisel point fork, and a blunt tip fork. Such forks may be selected for mounting with an accessory, for example, a roll clamp, a bale clamp, a side shift, a multi pallet handler, a push-pull, a rotator, a load stabilizer, a bucket, an inverter clamp, a pusher, a side clamp, a ram, a crane arm, or other accessory.

Referring again to FIG. 1, the pusher accessory 110 may be used for depositing or retrieving cargo 120 from the cargo aircraft 140. The cargo aircraft 140 is an example of a transport vehicle. The pusher accessory 110 may deposit or retrieve cargo from a transport vehicle. The transport vehicle may be, for example, a rail car, a trailer, a barge, a space vehicle, a sled, a ship, a truck, a blimp, or a hovercraft. The transport vehicle may transport the cargo 120 from one location to another, for example, Hong Kong to San Francisco.

The pusher accessory 110 may receive the fork 150. The pusher accessory 110 may mount to, or be attached to the fork 150. The pusher accessory 110 may be moved horizontally, vertically, rotated, or tilted by the fork 150. The forklift truck 105 may move the pusher accessory 110. When the pusher accessory 110 is moved, the cargo 120 may be displaced along the conveyor 130.

The conveyor 130 is an example of a material handling surface. The machine may displace the cargo 120 along a material handling surface, for example, a dock, a dock board, a platform, a dock leveler, a ramp, a slave/staging rack, or other surface.

The conveyor 130 may be constructed with a plurality of rollers. The conveyor 130 may include a low friction surface coating, for example, PFTE, to reduce static, sliding, and/or rolling friction. The pusher accessory 110 may be used in conjunction with a slip sheet for displacing the cargo 120 along a surface with a minimal amount of friction.

The cargo 120, for example, may be a container covered in plastic, a crate, a common shipping box, or a good wrapped in blankets or plastic. The cargo 120 may also include a canvas slip sheet disposed at the bottom of the cargo 120. The canvas slip sheet may reduce static, sliding, and/or rolling friction when the cargo 120 is displaced along the conveyor 130. If friction is minimized, less force and less work may be required to displace the cargo 120.

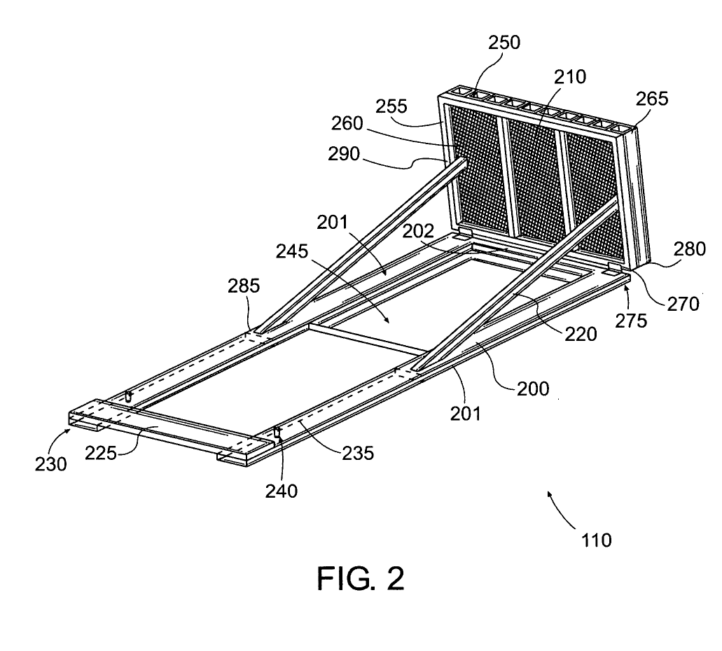

Referring now to FIG. 2, there is shown a plan view of the pusher accessory 110. The pusher accessory may comprise a first section 200, a second section 210, and a detachable member 220. The second section 210 may be pivotally joined to the first section 200. The detachable member 220 may be affixed to both the first section 200 and the second section 210 at locations other than where the second section 210 is pivotally joined to the first section 200.

The first section 200, for example purposes, may be constructed of tubing. The tubing may be configured of two longitudinal sections 201 and a lateral section 202. The geometry of the first section 200 may be a solid plate, a truss, or a grid. The cross section of the first section 200 may be two inches by six inches by ⅛″ thick. The cross section of the first section 200 may be a ⅛″ thick and 4″ diameter circle, a solid square 3″ in length, a variable cross section, or other geometry. The geometry of the cross section of the first section 200 may be selected to provide torsional, bending or sheer rigidity. For example, it is well known that “I” shaped cross sectional beams and cylindrical tubes provide more resilience to bending forces than a flat panel.

The length of the first section 200 may be seven feet, or another length. The length of the first section 200 may be selected commensurate with the length of the fork 150. When the length of the first section 200 is commensurate with the length of the fork 150, the fork 150 may provide rigidity to the first section. The length of the first section 200 may be a different length than the length of fork 150. When the length of the first section 200 is longer than the length of the fork 150, the forklift truck 150 may be kept away from the cargo 120 or the transport vehicle. The length of the first section 200 may be shorter than the length of the fork 150 if rigidity is of little concern and/or the cargo 120 has a small size and/or small mass.

The width of the first section 200 may be three feet, or another length. The width of the first section 200 may be selected commensurate with the positioning of two forks 150 on the forklift truck 105. The width of the first section 200 may be selected commensurate with the geometry of the cargo 120, or other dimension.

The first section 200 may be constructed of a steel material. Alternatively, the first section 200 may be constructed of aluminum, wood, a composite, or other material. The material, geometry and construction may be selected based on strength and rigidity of the loads that the pusher apparatus 110 may experience when displacing the cargo 120.

The first section 200 may comprise a member 225 attached to the first end 230 of first section 200. The member 225 may provide mechanical rigidity and strength to the first section 200. The member 225 may be attached to the first end 230 via a welding or a fastener. The fastener may be a screw, bolt, rivet, pin, or other fastener.

The first section 200 may comprise a fork sleeve 235. The fork sleeve 235 may be disposed within the first end 230 of the first section 200. The fork sleeve 235 may be configured to receive the fork 150 of the forklift truck 105. The fork sleeve 235 may define a hollow section within the first section 200. The fork sleeve 235 may have a geometry commensurate with the fork 150 and slightly larger than the fork 150. When the size and shape of the fork 150 and the fork sleeve 235 are similar, the fork 150 may fit in the fork sleeve 235 with an interference fit. The fork 150 may be secured to the first section 200 with a set screw 240, a latch, a clip, a pin, a lock, or another fixing element.

The fork sleeve 235 may be hardened in order to sustain the transfer of forces from the fork 150. Forces may be applied by the fork 150 to the fork sleeve 235 when the forklift truck 105 displaces the cargo 120, raises or lowers the pusher accessory 10, tilts the pusher accessory 110, or supports the weight of the pusher accessory 110.

The first section 200 may include a deck 245. The deck 245 may be used for supporting materials. The deck 245 may be used to provide additional rigidity to the first section 200. The deck 245 may be affixed to longitudinal section 201 and/or the lateral section 202 via a welding or a fastener. The deck 245 may be integral to the first section 200. The deck 245 may be constructed of steel, composite, plastic, diamond plate aluminum, or other material. Examples of things that may be supported on the deck 245 include construction cones, people, slip sheet canvases, and rolls of plastic wrap. The deck 245 may support a LNG tank for fueling the forklift truck 105.

The second section 210, for example, may be constructed of tubing. Alternatively, the second section 210 may be constructed of beams, or flat bars. The second section 210 may have two longitudinal sections 250 and four lateral sections 255. Additional configurations of the second section 210 may include a generally square shape with four sections including cross bars in an “X” shape configuration, and a solid flat plate.

The tubing may have a general rectangular cross-section. The cross sections of the tubing may be 2″ by 2″ by ⅛″ thick, a 3″ diameter circle with ¼″ thickness, a solid square 4″ in length, or other geometry. The geometry of the tubing cross section may be selected based on operational rigidity requirements. The length of the second section 210 may be three feet, or another length. The length of the second section 210 may be selected commensurate with the width of the first section 200, the geometry of a standard cargo 120, or other dimension. The height of the second section 210 may be two feet, or another length. The height of the second section 210 may be selected based on a fixed ratio to the length of the section, the geometry of a standard cargo 120, or other dimension.

The second section 210 may include a panel 260. The panel 260 may be attached to the longitudinal sections 250 and the lateral sections 255. The panel 260 may be attached via a welding, a fastener, or an adhesive. The panel 260 may be constructed, for example, of a wire mesh or a flat plate. When the forklift truck 105 is moving and the second section 210 is in contact with the cargo 120, the panel 260 may distribute a displacement force, originating from the vehicle, over the surface area of the panel 260 in contact with the cargo 120. By distributing the displacement force over a larger surface area than a single point or only the longitudinal sections 250 and lateral sections 255, the cargo 120 is less likely to be dented or damaged.

The pusher accessory 110 may contact the cargo 120 when the forklift truck 105 is pushing the cargo 120, or is stationary but preventing the cargo 120 from sliding down a slope. Examples of the types of forces that the pusher accessory 110 may exert on the cargo 120 are, for example, shock, compressive, tensile, sheer, torsional, and vibratory forces. Such forces may originate from the motor of the forklift truck 105, the surface that the forklift truck 105 is moving on, the surface that the cargo 120 is being displaced along, and the impact of the pusher accessory 110 into the cargo 120.

Forces exerted between the pusher accessory 110 and the cargo 120 may damage the cargo 120 and/or the goods inside the cargo 120. The forces exerted between the second section 210 and the cargo 120 may cause scratches and dents in the surfaces of both the cargo 120 and the second section 210. Such scratches may result in concentrated areas for rust to form. Moreover, repetitive impacts may result in denting and reduce the effective life of the cargo 120 and/or the second section 210.

The second section 210 may include a bumper 265. The bumper 265 may be affixed to the panel 260 or the longitudinal sections 250 and lateral sections 255. The bumper 265 may be a rubber slab having the same geometry as the panel 260. The bumper 265 may be a plurality of “D” shaped rubber tubes aligned vertically, adjacent to one another. The “D” shaped cross section of the rubber tubes may be 4″ in length by 2″ in width by ¼″ in thickness, or other dimensions.

The bumper 265 may provide dampening of the forces, shock, and vibration exerted between the pusher accessory 110 and the cargo 120. The bumper 265 may diminish or reduce the amplitude or intensity of the forces. The bumper may cause prevention of at least some dents and/or damage to the cargo 120. Additionally, the bumper 265 may protect the pusher accessory 110 from sharp or pointed surfaces such as the corner of a container. Moreover, the bumper 265 may protect a person should the pusher accessory 110 collide with a person.

The second section 210 may be pivotally joined to the first section 200 by a hinge 270. The second section 210 may be pivotally joined to the first section 200 by a pivot, a pin, a bearing, a race, or other fastener that allows for rotation about an axis. The hinge 270 may be positioned at a far end 275 of the first section and an end 280 of the second section 210.

The second section 210 may be configured at a ninety degree or other angle to the first section 200. In the ninety degree configuration, the first section 200 may be a horizontal section and the second section 210 may be a vertical section. The pusher accessory 110 may apply a force in the same direction as the motion of the forklift truck 105, thereby displacing the cargo 120.

The detachable member 220 may be affixed to the first section at a first location 285. The first location 285 may be at a position apart from the axis of the hinge 270. The detachable member 220 may be affixed to the second section 210 at a second location 290 apart from the axis of the hinge 270. When the pusher accessory 10 includes three separate points of connection, the pusher accessory 110 may have a rigid structure. The structure of the pusher accessory 110 may provide strength and durability.

The detachable member 220 may be a four foot long tube with a square cross section of 2″ by 2″ by ⅛″ thickness. The detachable member 220 may have an alternate cross section geometry, for example, an “I” shape, an oval shape, or a circular shape. The length of the detachable member 220 may be two feet or eight feet. The detachable member 220 may be constructed of steel, aluminum, a composite, wood, or other material.

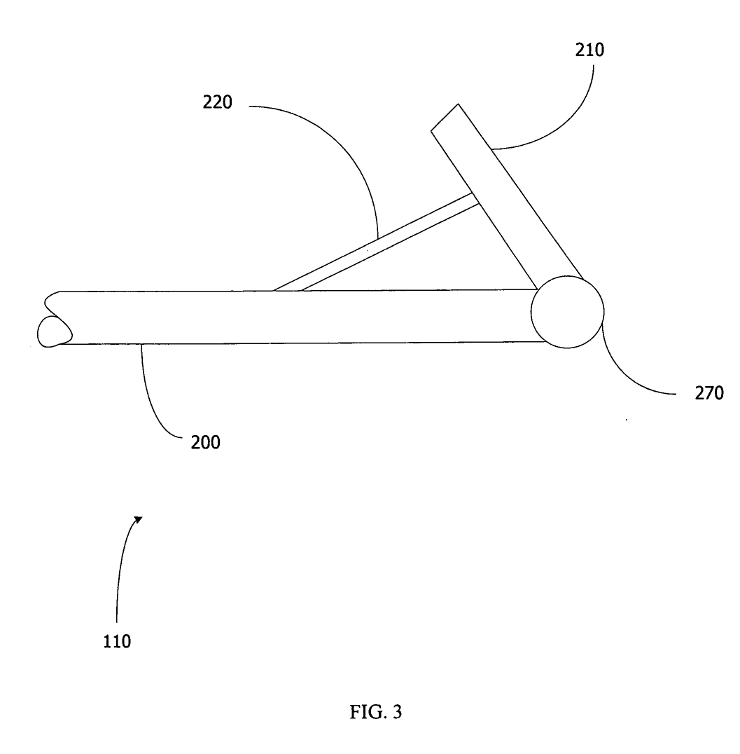

Referring now to FIG. 3, there is shown a perspective view of the pusher accessory 110. The second section 210 may be positioned at an incline angle relative to the first section 200. When the forklift truck 105 is moving along the ground and the pusher accessory 110 contacts the cargo 120, the pusher accessory 110 may provide a force with both a horizontal and vertical component, thereby pushing the cargo up an incline conveyor 130.

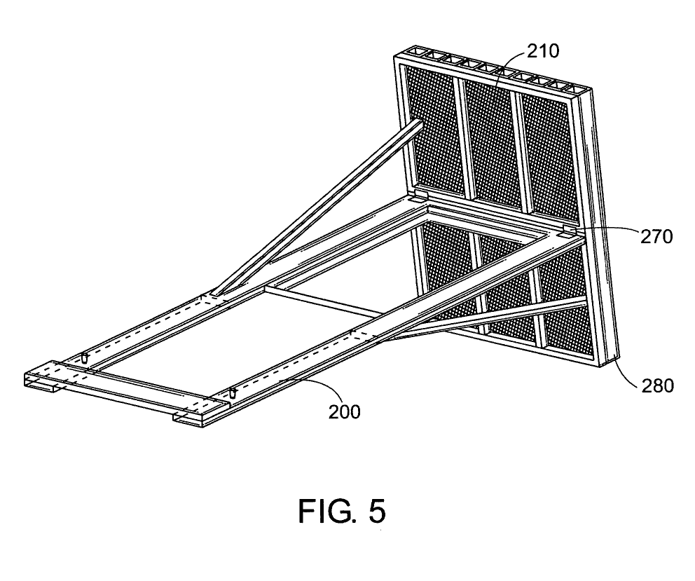

Referring now to FIG. 5, there is shown a plan view of the pusher accessory 110. The hinge 270 may be positioned at a position apart from the end 280 of the second section 210. In this configuration, a portion of the second section 210 may be positioned below the first section 200. The hinge 270 may be secured to both the first section 200 and the second section 210 with a fastener or a welding. The hinge 270 may be disassembled such that the second section 210 may be disjoined from the first section 200. Therefore, the second section 210 may be disjoinable from the first section 200. “Disjoinable” refers to the ability to be disjoined.

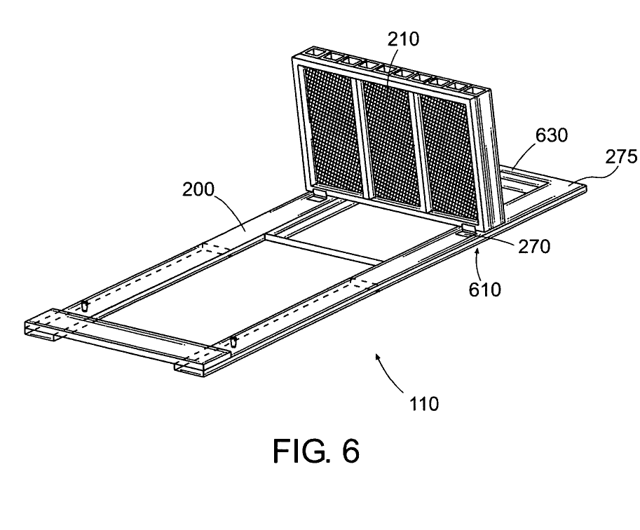

Referring now to FIG. 6, there is shown a plan view of the pusher accessory 110. The hinge 270 may be positioned at a third location 610 of the first section 200. In this configuration, the pusher accessory 110 may contact a non-standard shaped cargo both with the second end 275 of the first section 200 and the second section 210. The second end 275 of the first section 200 may engage a mounting or a sleeve of the cargo 120.

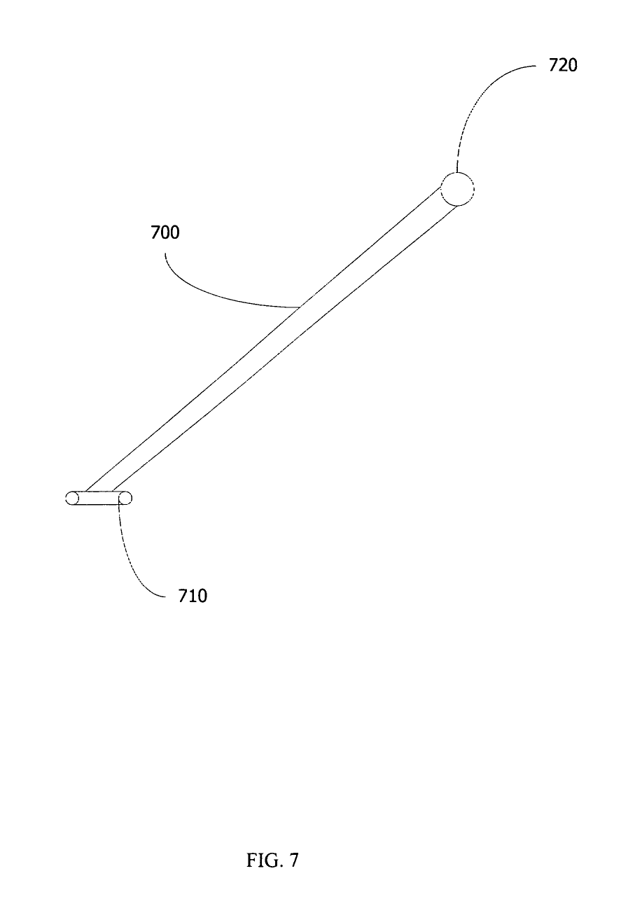

Referring now to FIG. 7, there is shown a perspective view of a detachable member 700. The detachable member 700 may include a slide mechanism 710. The slide mechanism 710 may affix the detachable member 700 to the first section 200. The pivot mount 720 may affix the detachable member 700 to the second section 210. The slide mechanism 710 may include a wheel, a pivot, and/or a race. The slide mechanism 710 may provide for variable positioning of the detachable member 700 relative to the first section 200.

When the detachable member 700 slides relative to the first section 200, the detachable member 700 may rotate about the pivot mount 720, and the second section 210 may rotate about the hinge 270. The slide mechanism 710 may be fixed in a variety of positions relative to the first section 200 via a latch, a ratchet, a set screw, or a locking mechanism.

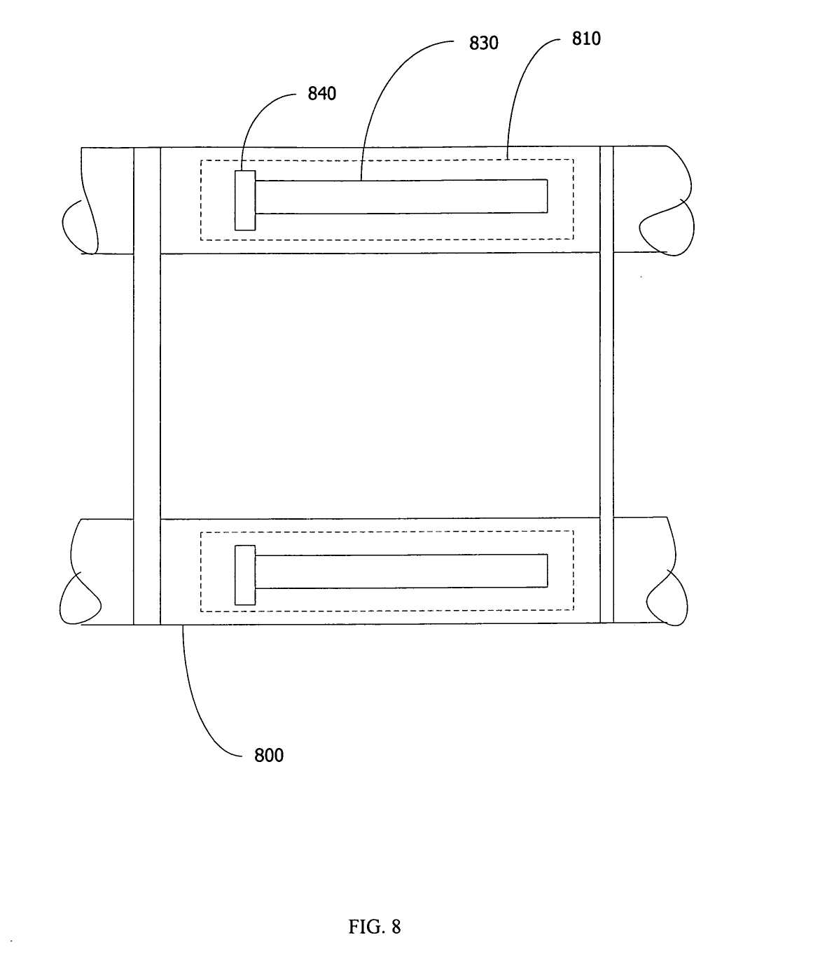

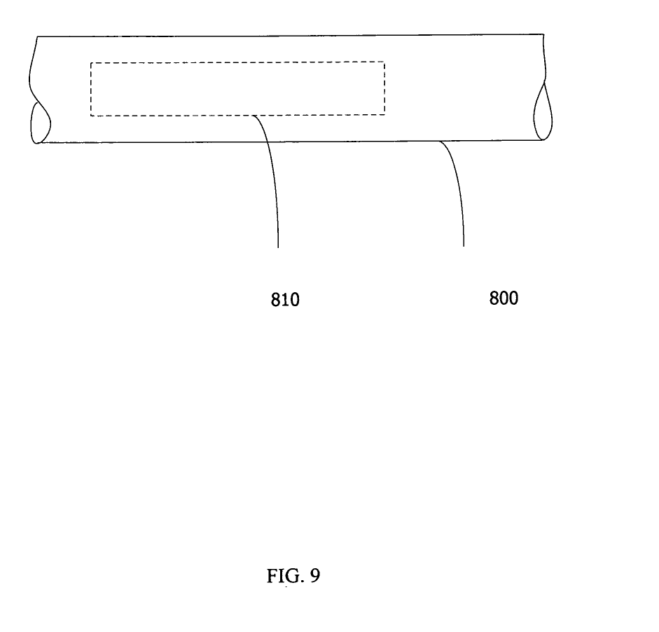

Referring now to FIG. 8, there is shown a plan view of a first section 800. The first section 800 may include a slide cavity 810. The slide mechanism 710 of the detachable member 700 may slide relative to the slide cavity 810. The slide cavity 810 may include an opening 830 for the detachable member 700 to fit through and remain attached to the slide mechanism 710. The opening 830 may be smaller in width than the slide mechanism 710. When the slide mechanism 710 is disposed within the slide cavity 810, the slide mechanism 710 may not dislodge from the first section 800. For illustration purposes, a partial perspective view of the first section 800 including the slide cavity 810 is shown in FIG. 9.

The slide mechanism 710 may be detached from the first section 800 by rotating the slide mechanism 710, by sliding the detachable member 700 to an engagement/disengagement section 840 of the opening 230, or by removing a fastener.

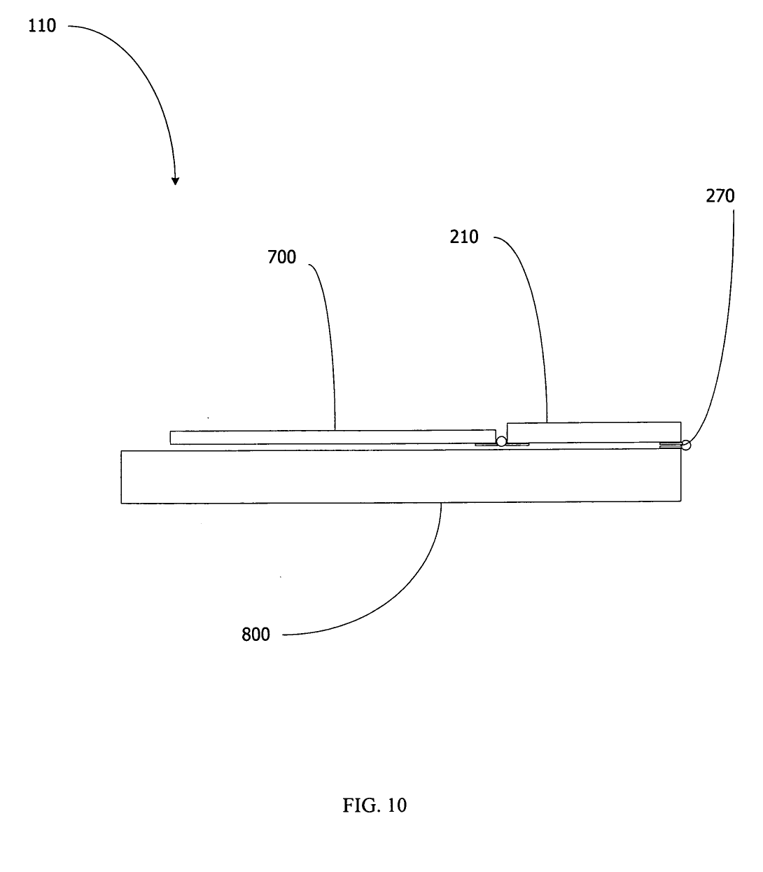

Referring now to FIG. 10, there is shown a pusher accessory 110. The pusher accessory 110 may be configured in a collapsed mode. When the detachable member 700 is detached from the first section 800, the second section 210 may be rotated about the hinge 270 to a configuration where the second section 210 is lying flat relative to the first section 800. In this configuration, the pusher accessory 110 may be readily stacked with a plurality of pusher accessories 110 or other goods or cargo 120. Because the pusher accessory 110 may be folded up or at least partially disassembled, less volume may be required for storage and/or shipment than if the second section 210 is at a fixed ninety degree angle relative to the first section 800. If less volume is required for shipping the pusher accessory 110, shipping costs may be saved.

A manufacturer of pusher accessories 110 may ship a plurality of pusher accessories 110 to a customer or a distributor. A logistics company that manages loading and unloading of cargo at a port may use a plurality of pusher accessories 110. The logistics companies may maintain spare pusher accessories 110 for times where there are higher work volumes and for times when a pusher accessory 110 fails. Because the pusher accessory 110 may be folded up or at least partially disassembled, manufacturers, distributors, and purchasers of the pusher accessories 110 may maintain a smaller inventory location for the pusher accessories 110 than if the second section 210 is fixed at a ninety degree angle to the first section 800. If the space required for an inventory location of a manufacturing facility, a distribution warehouse, or a stockroom is smaller, rent may be saved.

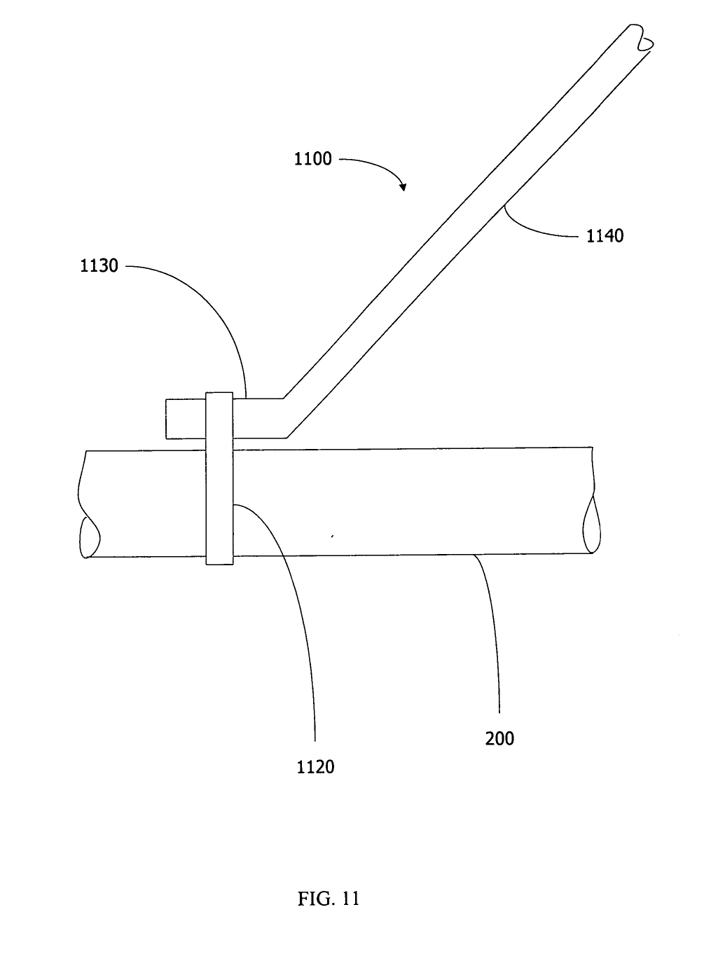

Referring now to FIG. 11, there is shown a partial perspective view of a detachable member 1100. The detachable member 1100 may be affixed to a first section 200 by a sleeve 1120. The detachable member 1100 may include an end 1130 which is at an angle to the body 1140 of the detachable member 1100. The end 1130 may be parallel to the first section 200. The sleeve 1120 may be attached to the first section 200 via a welding, a fastener, or be integral to the first section 200. The sleeve 1120 may be disposed in a variety of positions relative to the first section 200. The sleeve 1120 may be fixed to the first section 200 via a fastener or welding. The sleeve 1120 may clamp the end 1130 of the detachable member 1100 to the first section 200. The detachable member 1100 may be separated from the first section 200 by unclamping the sleeve or sliding the detachable member 1100 out of the sleeve 1120.

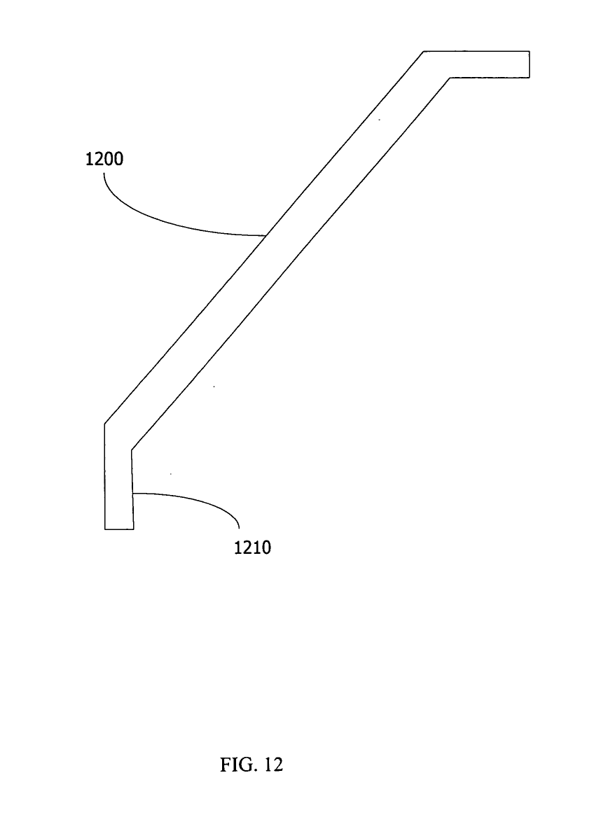

Referring now to FIG. 12, there is shown a perspective view of a detachable member 1200. The detachable member 1200 may include a first end 1210. The first end 120 may affix the detachable member 1200 to the first section 200. The first end 1210 may take the form of a peg, a leg, a tab, a tooth, a hook, an anchor, or a pin. The first end 1210 may be adapted to fit, at least partially into a hole or a depression.

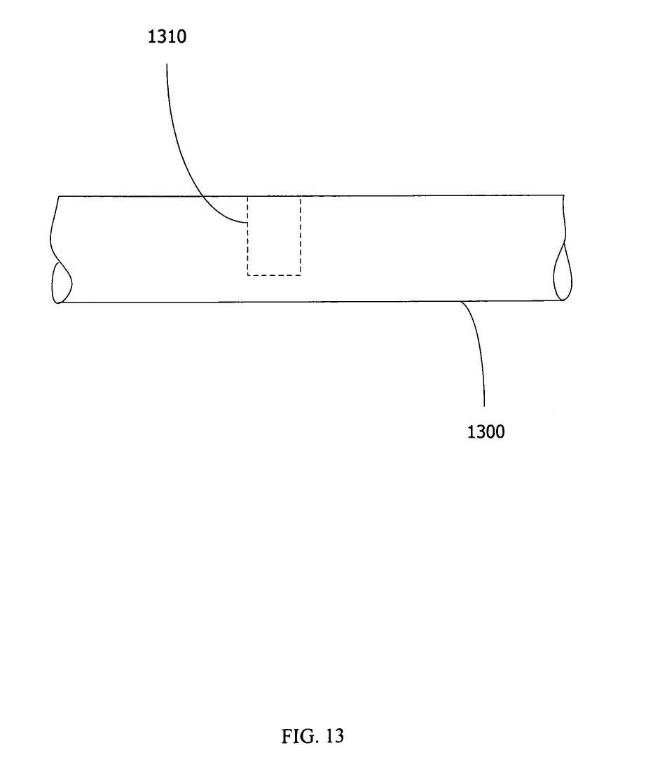

Referring now to FIG. 13, there is shown a partial perspective view of a first section 1300. The fist section 1300 may include a hole 1310 for receiving the first end 1210 of the detachable member 1200. The hole 1310 may have a cross sectional shape of a square, a circle, or other shape. The hole 1310 may be slightly larger in cross section than the cross section of first end 1210 of the detachable member 1200. When the first end 1210 is inserted into the hole 1310, there may be an interference fit between the detachable member 1200 and the first section 1300. Alternatively, when the detachable member 1200 is disposed within the hole 1310, the detachable member 1200 may be affixed to the first section 1300 with a pin or a set screw. The detachable member 1200 may be detached from the first section 1300 in order to disassemble or fold up the pusher accessory 110 in preparation for packing, storing and/or shipping.

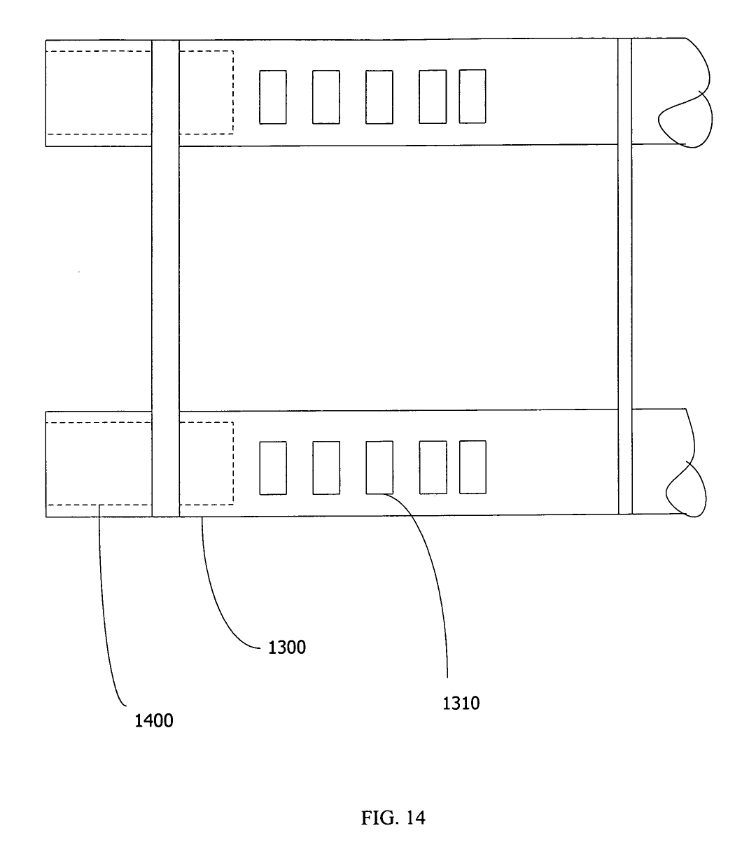

Referring now to FIG. 14, there is shown a partial plan view of the first section 1300. The first section 1300 may include a plurality of holes 1310. The holes 1310 may provide for a plurality of positions where the detachable member 1200 may affix to the first section 1300. The selection of the specific position to affix the detachable member 1200 to the first section 1300 may be selected based on the desired angle of the second section 210 relative to the first section 1300. For example, when the detachable member 1200 is affixed to the first section 1300 close to the fork sleeve 1400, the pusher accessory 110 may be configured to displace cargo up an incline while the forklift truck 105 is moving horizontally. When the detachable member 1200 is affixed to the first section 1300 far from the fork sleeve 1400, the pusher accessory 110 may be configured to displace cargo down a decline.

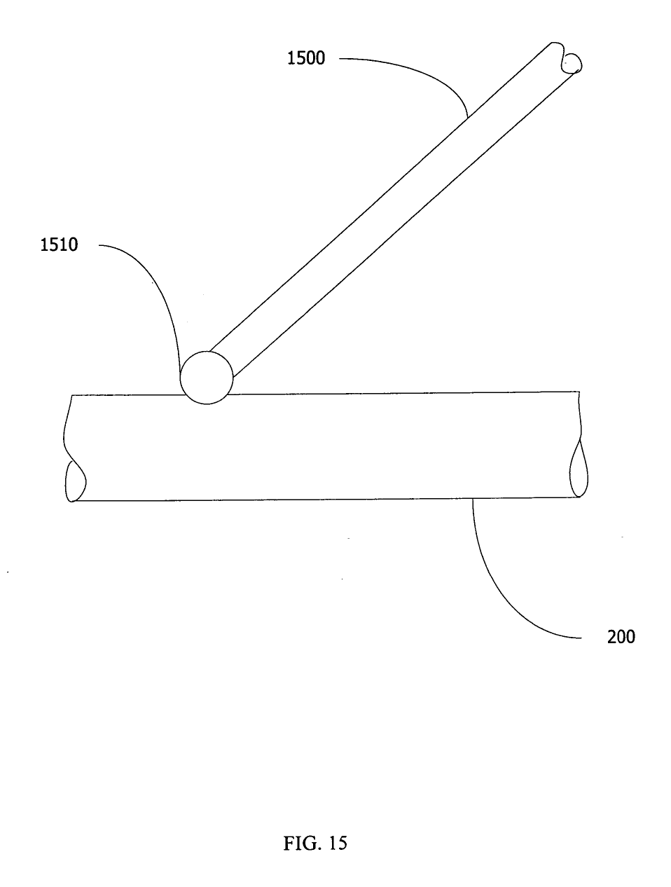

Referring now to FIG. 15, there is shown a partial perspective view of a detachable member 1500. The detachable member 1500 may be affixed to a first section 200 via a hinge 1510. The hinge 1510 may be a standard steel hinge, a pivot, a pin, or other fastener. The detachable member 1500 may rotate about the hinge 1510. When the detachable member 1500 rotates about the hinge 1510, the second section (not shown) may rotate about the first section 200 and/or slide relative to the first section 200. The detachable member 1500 may disengage from the first section 200 by removing the hinge, pivot, pin or other fastener. When the detachable member 1500 is not affixed to the first section 200, the pusher accessory 110 may be disassembled or folded up in preparation for packing, storing or shipping.

Referring again to FIG. 2, the detachable member 220 may be affixed to the second section 210 via a hinge, a peg, a sleeve, a slide or other. The detachable member 220 may be affixed to the second section 210 such that the second section 210 may be positioned relative to the first section 200 at a variety of angles. The detachable member 220 may rotate, slide, and/or detach from the second section 210 such that the pusher accessory 110 may be folded up or disassembled.

During normal operation of the pusher accessory 110, it is possible that the second section 210, the first section 200, or the detachable member 220 may be damaged or fail. Because at some of the components of the pusher accessory 10 may be disassembled from one another, the component which has been damaged or failed may be replaced. Upon failure, replacing a component may be less costly than replacing the pusher accessory 110.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications and alterations should therefore be seen as within the scope of the present invention.

1. A pusher apparatus comprising:
a horizontal section comprising two fork sleeves, each fork sleeve receiving a fork of a machine
a vertical section for pushing a load, the second section hinged to the horizontal section, the hinge removable from the horizontal section, the hinge removable from the vertical section
a detachable member for supporting the vertical section, the detachable member affixed to the vertical section apart from an axis where the second section is hinged to the horizontal section, the detachable member affixed to the horizontal section apart from the axis.

2. The pusher apparatus of claim 1, wherein the machine is a forklift truck.

3. The pusher apparatus of claim 2, wherein the forks are attached to the fork sleeves with a set screw.

4. A pusher apparatus comprising:
a first section comprising a fork sleeve
a second section for pushing a load, the second section pivotally joined to the first section, the second section disjoinable from the first section
a detachable member for supporting the second section, the detachable member affixed to the second section apart from an axis where the second section is pivotally joined to the first section, the detachable member affixed to the first section apart from the axis.

5. The pusher apparatus of claim 4, wherein the second section is pivotally joined to the first section with a fastener selected from the group comprising a hinge, a pivot, and a pin.

6. The pusher apparatus of claim 5, wherein the second section is pivotally joined to the first section apart from the end of the second section.

7. The pusher apparatus of claim 4, wherein a bumper is affixed to the second section.

8. The pusher apparatus of claim 7, wherein the bumper is a “D” shaped rubber bumper.

9. The pusher apparatus of claim 5, wherein the detachable member is affixed to the first section with an element selected from the group comprising a pin, a tab, a tooth, a hook, an anchor, a sleeve, and a fastener.

10. The pusher apparatus of claim 9, wherein the detachable member is affixed to the second section with an element selected from the group comprising a pin, a tab, a tooth, a hook, an anchor, a sleeve, and a fastener.

11. The pusher apparatus of claim 5, wherein the detachable member is affixed to the first section via a locking slide mechanism.

12. The pusher apparatus of claim 11, wherein the detachable member is affixed to the second section via a locking slide mechanism.

13. The pusher apparatus of claim 4, wherein the pusher apparatus is collapsible for storage and shipping.

14. The pusher apparatus of claim 1 wherein the machine is a baggage tractor.
